(19) United States
(12) Patent Application Publication
(10) Pub. No.: US 2014/0311670 A1
(43) Pub. Date: Oct. 23, 2014

(54) ASSEMBLING SYSTEM AND ASSEMBLING METHOD FOR A BACKLIGHT MODULE

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 14/244,906

(22) Filed: Apr. 4, 2014

(30) Foreign Application Priority Data
Apr. 19, 2013 (TW) 102113870

(51) Int. Cl. B29C 65/50

(52) U.S. Cl. CPC B29C 65/5057
USPC 156/297; 156/358

(57) ABSTRACT

An assembling system for assembling a backlight light module includes a receiving device, a pressing unit, a driving unit, an image module and a platform. The platform defines a bearing area to accommodate the receiving device. The receiving device includes a receiving room configured for receiving components of a backlight module. The pressing unit is configured for pressing the components to form the backlight module. The driving unit includes a driving device and a control unit. The driving device is used for driving the pressing unit to press the backlight module. The image module includes a camera and an image processor, the camera is configured for capturing images of the pressing unit during the pressing process, the image processor is configured for receiving and processing the images and generating a corresponding control signal, the control unit receives the control signal and control the driving device according to the control signal.

### BACKGROUND

1. Technical Field

The present disclosure relates to assembling systems, and particularly to an assembling system and assembling method used for assembling a backlight module.

2. Description of Related Art

Backlight modules generally include a liquid crystal unit, a light source, and a frame. In order to reduce a degree and a weight of the backlight module, tenons and screw are replaced by a double-sided adhesive to adhere the liquid crystal unit, the light source, and the frame together. In order to increase an adhesive stability of the double-sided adhesive, an external force must be applied on the backlight module. However, as the strength applied on the backlight module is hard to control, which results that the backlight module will be easily damaged.

Therefore, it is desirable to provide an assembling system that can overcome the above-mentioned problems.

### BRIEF DESCRIPTION OF THE DRAWINGS

FIG. 1 is an isometric view of an assembling system in accordance with an exemplary embodiment.

FIG. 2 is an isometric view of a pressing unit and a receiving device of the backlight module of FIG. 1

FIG. 3 is a functional block diagram of the assembling system of FIG. 1.

FIG. 4 is an exploded view of a pre-pressed backlight module.

FIG. 5 is similar to FIG. 4, but viewed from another angle.

FIG. 6 is an isometric view of a backlight module.

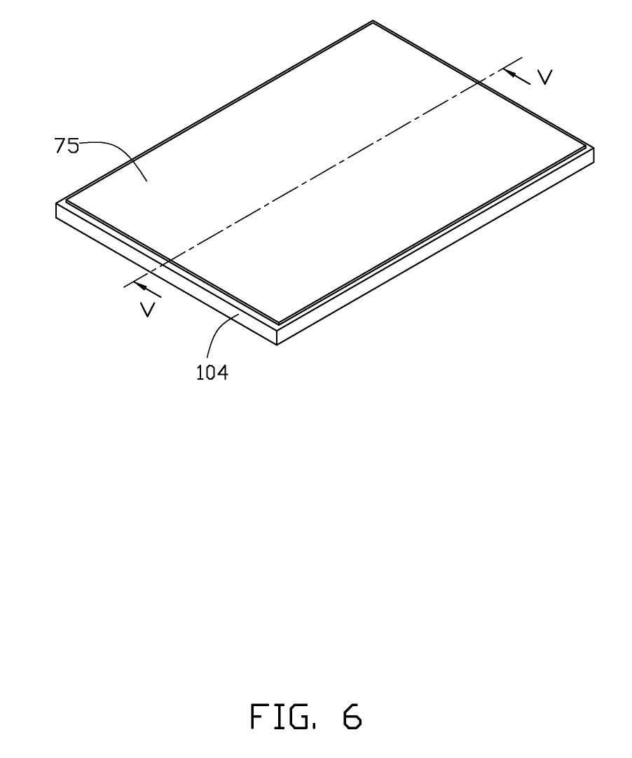

FIG. 7 is a cross-sectional view of a backlight module along line VI-VI in FIG. 6

FIG. 8 is an isometric view of the backlight module being assembled by the assembling system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”. The references “a plurality of” and “a number of” mean “at least two.”

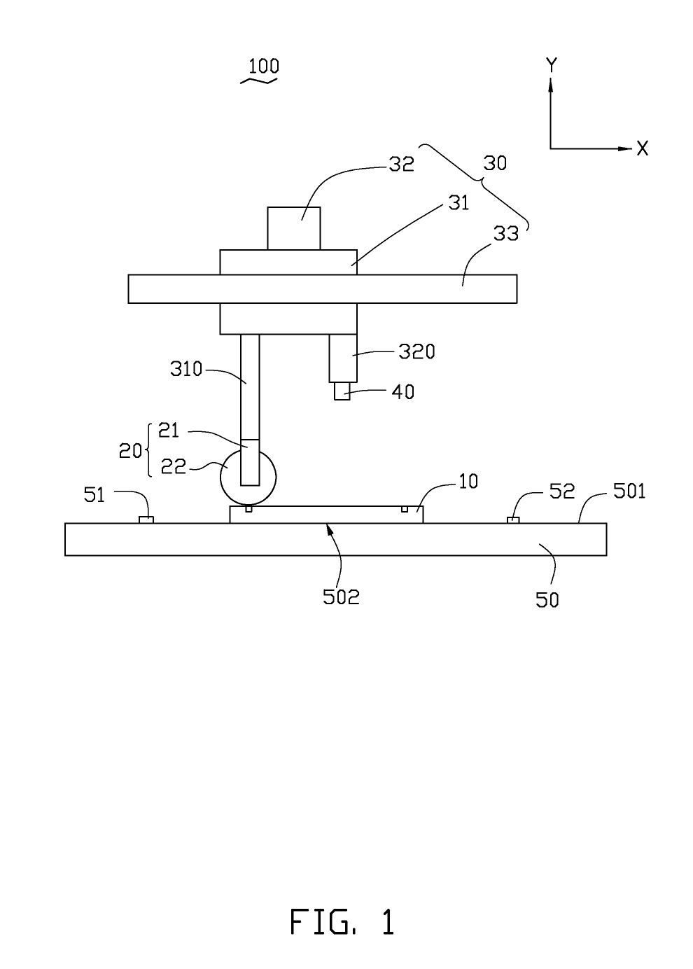

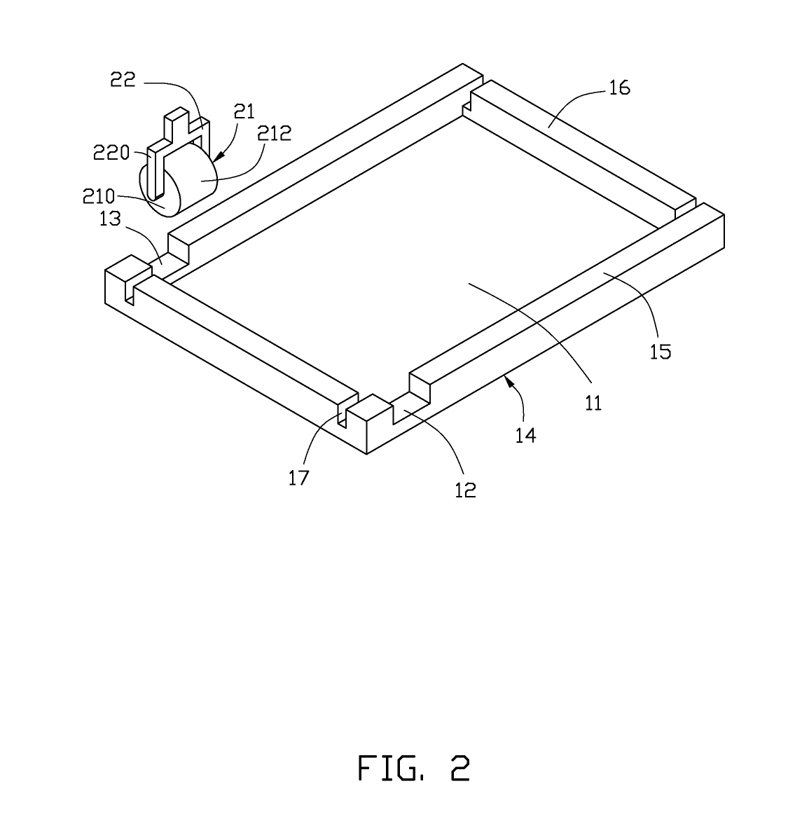

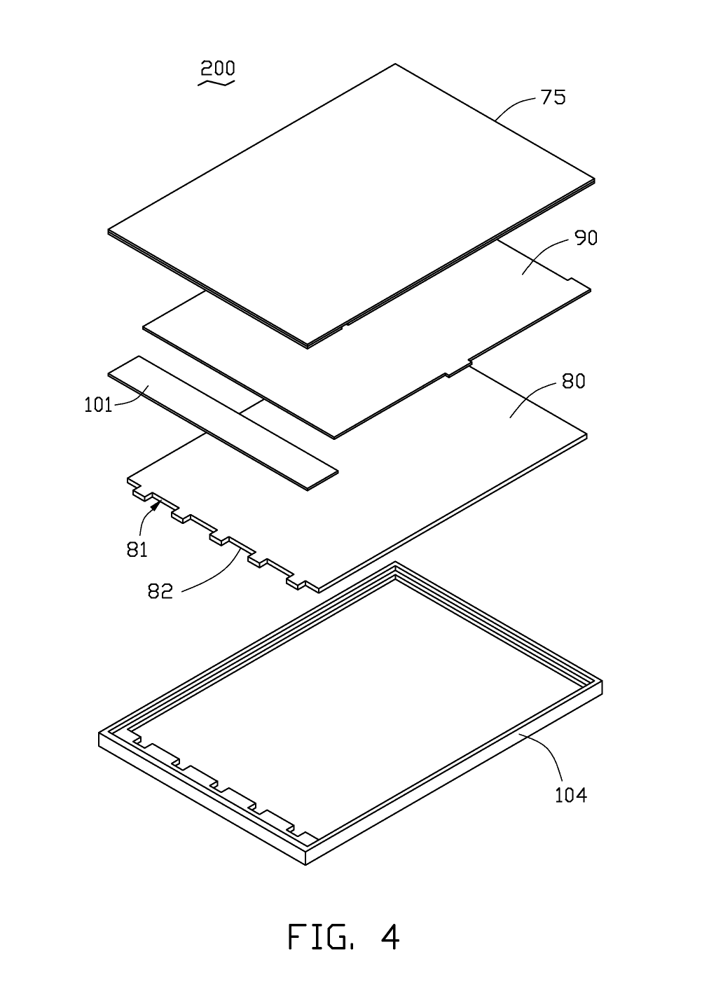

FIGS. 1-3 show an assembling system 100 according to an exemplary embodiment. The assembling system 100 includes a receiving device 10, a pressing unit 20, a driving unit 30, an image module 40, and a platform 50. In the embodiment, the assembling system 100 is used for assembling a pre-assembled backlight module 200 (referring to FIG. 4).

The receiving device 10 includes a bottom plate 14, two first blocks 15, and two second blocks 16. The bottom plate 14 is cubic. The two first blocks 15 respectively are positioned at two opposite edges of the bottom plate 14. The two first blocks 15 are parallel to each other. The two second blocks 16 respectively are positioned at another two opposite edges of the bottom plate 14.

The two second blocks 16 are parallel to each other, and perpendicular to the first blocks 15. The two first blocks 15, the two second blocks 16, and the bottom plate 14 together form a receiving room 11. The receiving room 11 is substantially cubic.

The two first blocks 14 respectively define a first cutout 12 and a second cutout 13, generally adjacent to one of the first blocks 14. The first cutout 12 faces the second cutout 13. A size of the first cutout 12 is the same as a size of the second cutout 13. Both of the first cutout 12 and the second cutout 13 communicate with the receiving room 11. The first cutout 12 and the second cutout 13 both are cubic.

The two second blocks respectively define two slots 17, and each the slot 17 is adjacent to the end of the first blocks 14. In the embodiment, the slots 17 are defined at the two opposite ends of the second blocks 16 and the number of the slots 17 is four. The slots 17 are configured for conveniently removing the backlight module from the receiving room 11.

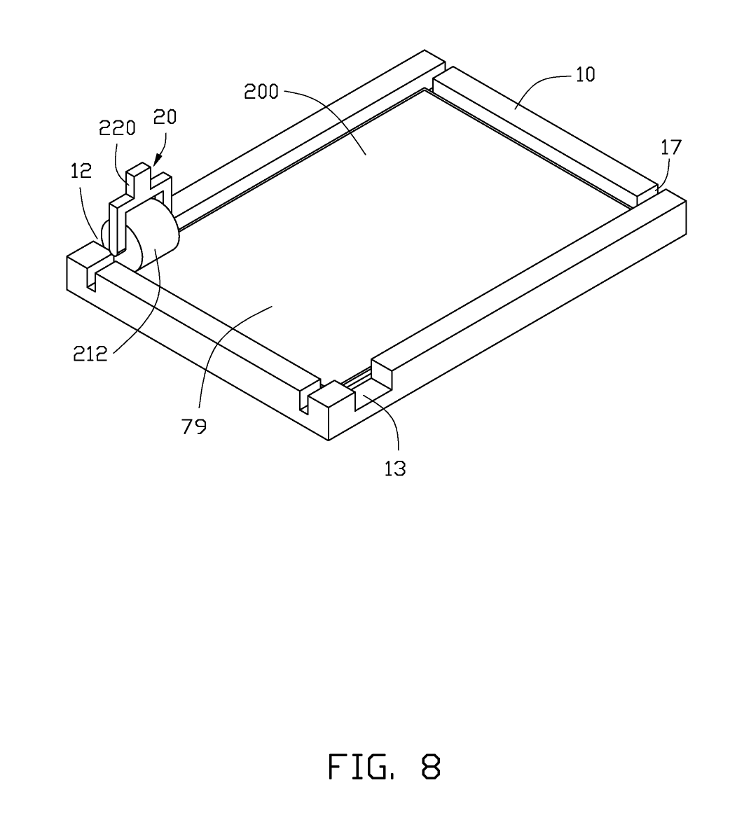

The pressing unit 20 includes a roller 21 and a holding portion 22. The roller 21 includes two side surfaces 210 opposite to each other. One end of the holding portion 22 includes two clamps 220, and the two clamps 220 clamp on the two side surfaces 210 of the roller 21. and a circumference 212 of the roller 21 is exposed from the clamps 220, the roller 21 is able to rotate around a central portion. The roller 21 is made of rubber or foam. Rubber or foam is capable of avoiding damage to the pre-pressed backlight module 200 during the pressing process. The pressing unit 20 is configured for pressing a double-sided adhesive 75, as shown in FIG. 8, and using the double-sided adhesive 75 to adhere the components of the pre-pressed backlight module 200 stability.

The driving unit 30 includes a driving device 31, a control unit 32, and a horizontal axis 33. The driving device 31 is movably fixed on the horizontal axis 33, and is capable of moving along the horizontal axis 33. The driving device 31 includes a first arm 310 and a second arm 320 parallel to the first arm 310. A length of the first arm 310 is adjustable. The pressing unit 20 is fixed at an end of the first arm 310 facing away from the horizontal axis 33.

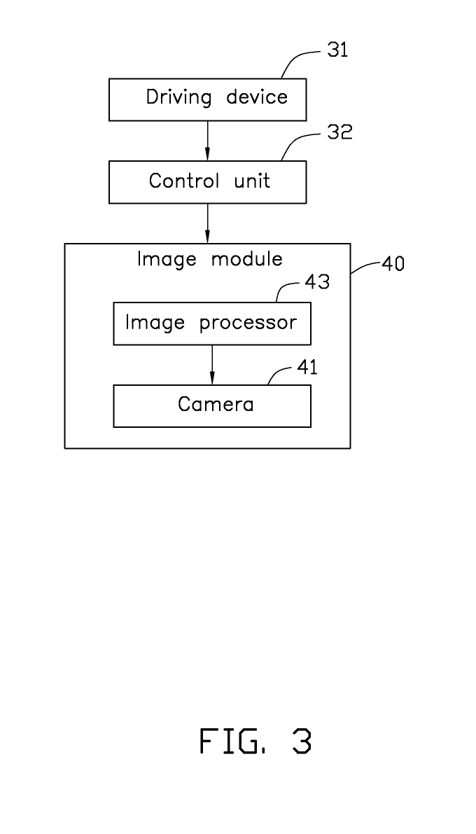

The image module 40 is electrically connected to the driving unit 30, as shown in FIG. 3. The image module 40 includes a camera 41 and an image processor 43. The camera 41 is fixed ON an end of the second arm 320. The camera 41 is configured for capturing images of the pressing unit 20 relative to the first mark point 51 and capturing images of the pressing unit 20 relative to the second mark point 52 during a pressing process, the image processor 43 is configured for receiving and processing the images captured by the camera 41 and generating a corresponding control signal, the control unit 32 is configured for receiving the control signal and control the driving device 31 to move according to the control signal.

The platform 50 includes a top surface 501. The top surface 501 defines a bearing area 502 to accommodate the receiving device 10. The platform 50 further defines a first mark point 51 and a second mark point 52. A distance between the first mark point 51 and the second mark point 52 is larger than a distance between the first cutout 12 and the second cutout 13, the first mark point 51 is arranged adjacent to the first cutout 12. The second mark point 52 is arranged adjacent to the second cutout 13. A connection line between the first mark point 51 and the second mark point 52 is parallel to the second block 15.

A first position image and a second position image are pre-stored in the image processor 43, the first position image is captured by the camera 41 when the roller 21 is positioned at the first cutout 12, relative to the first mark point 51. The second position image is captured by the camera 41 when the roller 21 is positioned at the second cutout 13, relative to the second mark point 53.

A method for using the assembling system to assemble a backlight module comprising steps of:

S1: An assembling system 100 and components to form a pre-pressed backlight module 200 are provided. In the illustrated embodiment, a frame 104, a light guide plate 80, an optical film group 90, a light source bar 101 and a double-sided adhesive 75 are provided. The light guide plate 80 includes a light incident surface 81. The light incident surface 81 includes a number of light incident portions 82 arranged in interval. The light bar 101 includes a printed circuit board (PCB) 102 and a number of light sources 103 evenly spaced apart on the PCB 102. In this embodiment, the light sources 103 are light-emitting diodes (LEDs).

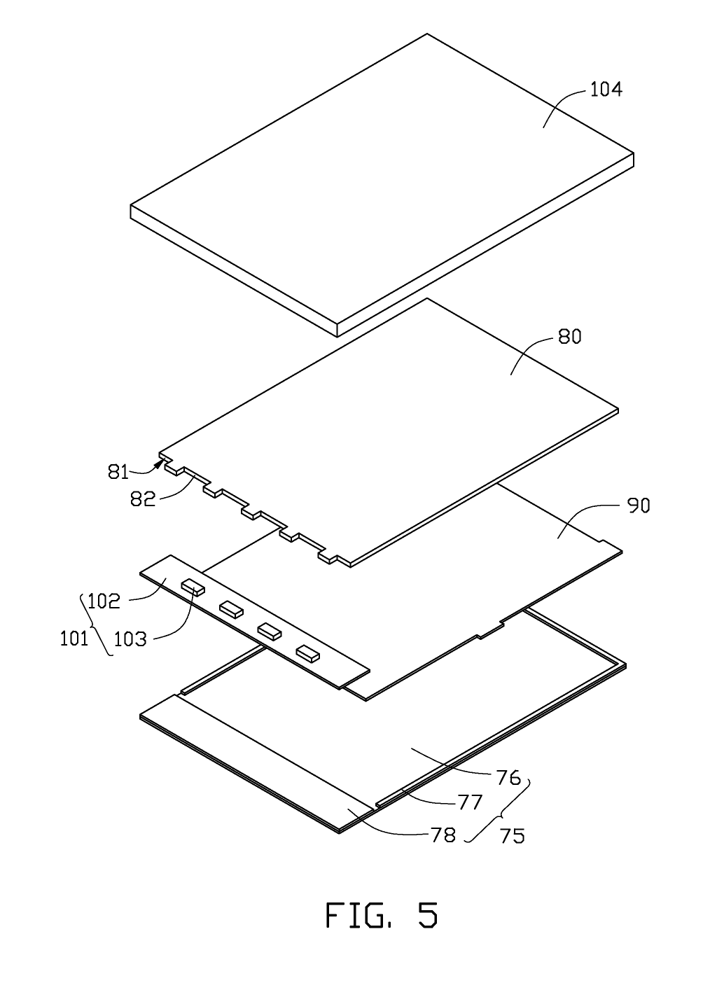

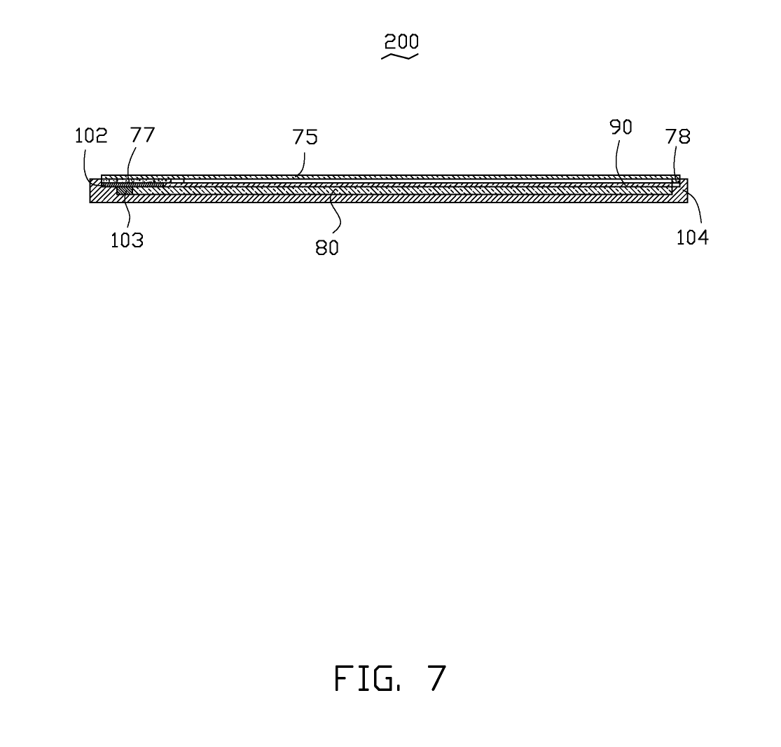

The double-sided adhesive 75 includes a protective film 76, a first adhesive part 77 arranged at the adjacent three side edges of the protective film 76 and a second adhesive part 78 at the fourth side edge of the protective film 76, as shown in FIG. 5. An area of the second adhesive part 78 is larger than an area of the printed circuit board 102, in this way, the printed circuit board 102 is easily fixed with the optical film group 90, as shown in FIG. 7. The optical film group 90 includes a stacked diffusing film and a bright enhancement film (not shown).

S2: The light guide plate 80, the light bar 101, and the optical film group 90 are placed into the frame 104 successively. The double-sided adhesive 75 is used to adhere to the frame 104. The light guide plate 80, the light bar 101, and the optical film group 90 are fixed in the frame 104 to form the pre-pressed backlight module 200.

In the illustrated embodiment, the light guide plate 80 is first placed into the frame 104, and the PCB 102 is arranged on the light guide plate 80, and the light sources 103 are facing the light incident portion 82. The optical film group 90 is placed on the light guide plate 80, a side surface of the optical film group 90 is side by side with a side surface of the PCB 102. The optical film group 90 is coplanar with the PCB 102. The double-sided adhesive 75 is covered on the PCB 102 and the optical film group 90. The first adhesive part 77 is exposed by the optical film group 90. The first adhesive part 77 is used for fixing to rims of the frame 104. The second adhesive part 78 is used for fixing the light bar 101 together with the optical film group 90. The roller 21 is configured for rolling on a pressing area 79 corresponding on top surface of the second adhesive part 78, as shown in FIG. 8.

S3: The pre-pressed backlight module 200 is placed into the receiving device 10, and the pressing area 79 is positioned between the first cutout 12 and the second cutout 13, and the receiving device 10 is then placed on the bearing area of the platform 60, and the pressing area 79 is arranged between the first mark point 51 and the second mark point 53, and the roller 21 is arranged above the pressing area 79, as shown in FIG. 1.

S4: The driving device 31 is powered on, and the roller 21 is driven to roll the pressing area 79 from the first cutout 12 as a start point. When the image processor 53 identifies that an image from the number of images captured by the camera during the pressing process is the same as the first position image, the processor 43 generates a first control signal at the same time. The control unit 32 receives the first control signal and drives the driving device 31 to move along the direction toward the second mark point 53. When the image processor 53 identifies an image is the same as the second position image, the processor 43 generates a second control signal, the control unit 32 receives the second control signal and stops the driving device 31 from moving. A complete press process starts from the first cutout 12 and ends at the second cutout 13. If the protecting film 76 is torn off, a liquid crystal unit is assembled on the first adhesive part 77 and second adhesive part 78, and a liquid crystal plate is obtained.

In summary, a rolling force on the backlight module 200 can be controlled by the roller 21 of the assembling system 100, so the yield assembly of backlight module is improved.

It is to be understood that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An assembling system for a backlight light module, comprising:
a receiving device;
a platform comprising a bearing area, a first mark point, and a second mark point; wherein the receiving device is placed between the first mark point and the second mark point, the receiving device defines a receiving room configured for receiving a backlight module, the receiving device comprising a first cutout and a second cutout facing to the first cutout, a distance between the first mark point and the second mark point is larger than a distance between the first cutout and the second cutout, the first cutout besides the first mark point, the second cutout besides the second mark point, both the first cutout and the second cutout communicate with the receiving room;
a pressing unit configuring for pressing the backlight module;
a driving unit arranged above the receiving device, the driving unit comprising a driving device and a control unit, the driving device comprising a first arm and a second arm parallel to the first arm, wherein a length of the first arm is adjustable, the pressing unit is fixed at an end of the first arm; and
an image module comprising a camera and an image processor, the image module is fixed at an end of the second arm, the camera is configured for capturing images of the pressing unit relatively to the first mark point or the second mark point during the pressing process, the image processor is configured for receiving and processing the images and generating a corresponding control signal according to the images, the control unit receives the control signal and control the driving device to move or stop.

2. The assembling system of claim 1, wherein the pressing unit comprises a roller and a holding portion, the roller comprising two side surfaces opposite to each other, one end of the holding portion clamps the two side surfaces and exposing the circumference of the roller, the other end of the holding portion is fixed with the first arm.

3. The assembling system of claim 1, wherein the receiving device comprises a bottom plate, two first blocks vertically connected with the bottom plate and two second blocks vertically connected with the bottom plate, the two first blocks parallel to each other, the two second blocks parallel to each other, the two first blocks, the two second blocks and the bottom plate together form the receiving room.

4. The assembling system of claim 3, wherein the first cutout and the second cutout are defined at one end of the two first blocks, the first cutout and the second cutout both adjacent to the two second blocks.

5. The assembling system of claim 3, wherein the receiving device further defines a plurality of slots, the slots are defined at the end of the second blocks adjacent to the first blocks.

6. The assembling system of claim 2, wherein the roller is made of rubber or foam.

7. The assembling system of claim 1, wherein the image processor is pre-stored a first position image and a second position image, the first position image is captured by the camera when the pressing unit is positioned at the first cutout position, a image of the pressing unit relative to the first mark point; the second position image is captured by the camera when the pressing unit is positioned at the second cutout position, a image of the pressing unit relative to the second mark point.

8. The assembling system of claim 1, wherein the driving unit further comprises a horizontal axis, the driving device is arranged at the horizontal axis and is capable of moving along the horizontal axis.

9. The assembling system of claim 1, wherein the receiving room is substantially a cubic.

10. A method for assembling a backlight module comprising:
providing an assembling system and forming a pre-pressed backlight module, the pre-pressed backlight module comprising a pressing area;
placing the pre-pressed backlight module into the receiving device, arranging the pressing area between the first cutout and the second cutout, placing the receiving device on the bearing area of the platform, and arranging the pressing area between the first mark point and the second mark point, and arranging the roller above the pressing area;
powering on the driving device, and the roller is driven to roll the pressing area from the first cutout as a start point.

11. The method of claim 10, wherein a method for forming the pre-pressed backlight module comprising :
providing a frame, a light guide plate, a light bar, an optical film group and a doubled-sided adhesive;
placing the light guide plate, the light bar, and the optical film group successively into the frame;
the optical film group is coplanar with the light bar, the double-sided adhesive is covered on the light bar, and obtain the pre-pressed backlight module.

12. The method of claim 11, wherein the double-sided adhesive comprising a protective film, a first adhesive part arranged at the adjacent three side edge of the protective film and a second adhesive part at the fourth side edge of the protective film.

13. The method of claim 11, wherein the first adhesive part is exposed by the optical film group, the first adhesive part is used for fixed with rims of the frame, the second adhesive part is used for fixed the light bar together with the optical film group, the pressing area is corresponding on top surface of the second adhesive part.
